(19) United States
(12) Patent Application Publication
(10) Pub. No.: US 2016/0017907 A1
(43) Pub. Date: Jan. 21, 2016

(54) SPLIT WEDGE DOVETAIL DOWEL

(71) Applicant: Kevin Patrick Ryan, Zionsville, PA (US)

(72) Inventor: Kevin Patrick Ryan, Zionsville, PA (US)

(21) Appl. No.: 14/333,394

(22) Filed: Jul. 16, 2014

(51) Int. Cl. F16B 12/12; E04B 2/08

(52) U.S. Cl. CPC F16B 12/125; E04B 2/08

(57) ABSTRACT

A configuration for split wedge dovetail dowels that provide attachment points along dovetail channels where wedge action locks the dovetail dowels in place through compression and friction without the need for glue or screws. This configuration can also be used to connect two members with matching dovetail channels by positioning the split wedge dovetail dowel across the joint between the two members.

### FIELD OF THE INVENTION

The present invention relates to dovetail joinery and more particularly, to dovetail dowels split into wedge shape halves longitudinally for joinery with dovetail shaped channels.

### BACKGROUND OF THE INVENTION

Dovetail shaped channels are used as attachment points for hanging utilities from ceilings and walls, and in wood joinery. Dovetail shaped dowels slide into dovetail channels to join two separate pieces together or to act as an attachment point for accessories.

Dovetail dowels must be slid in from the end of a dovetail channel along the channel until the dowel is positioned in the proper location along the channel. A dovetail dowel split longitudinally into two wedge shaped halves can each be placed directly into a dovetail channel without sliding them down from the ends. The two halves can then be positioned together to act as one piece.

Dovetail dowels must be glued or screwed in place to prevent the dowel from moving along the length of the dovetail channel. A dovetail dowel split longitudinally into two wedge shaped halves can together be sized to be slightly wider than the width of the dovetail channel. The two halves when positioned together will be compressed in the dovetail channel locking the dovetail dowel in place through friction.

Through this mechanism the dovetail dowel can tie two separate pieces together that have matching dovetail channel indentations. Through this mechanism the dovetail dowel can become an attachment point for finishes and accessories.

Split wedge dovetail dowels can be used in wood joinery such as furniture production and metal attachment channels for utilities. Split wedge dovetail dowels can be used in dovetail channels formed in plastics, concrete, masonry, metals, and woods.

The following example is one possible use in one possible combination of materials for this split wedge dovetail dowel configuration. This example is not to be taken in a limiting sense but as one possible use that illustrates the concept involved with split wedge dovetail dowels. The scope of the invention is best defined by the appended claims.

Masonry walls are made of cementitious materials. When used in home construction, masonry block walls must have furring strips applied at 16 inch centers to allow for the attachment of drywall to the interior of the walls. Drywall screws do not penetrate into masonry blocks but they do attach to wood furring strips. When drywall comes in direct contact with masonry blocks that are damp, the drywall can absorb moisture and mold can form.

While wood furring strips do not transfer heat as fast as masonry, wood does transfer heat from the drywall to the masonry reducing the energy efficiency of the home.

Masonry walls can resist the pressures from wind events such as tornadoes and hurricanes much better than walls constructed of 2×6 wood members. A more efficient, energy conserving, and mold resistant manor of attaching drywall finishes on the interior of masonry construction is needed. Wood furring strips are also used for exterior finishes on masonry walls and the same concepts apply.

Plastic split wedge dovetail dowels spaced in a 16 inch by 8 inch pattern on the face of a wall constructed of masonry blocks can replace wood furring strips that run from floor to ceiling at 16 inch centers used for the attachment of drywall. Masonry block is manufactured in molds and dovetail channels running full height from top to bottom at 8 inch centers can easily be formed in the face of these block using current block mold technology.

Two halves of a plastic split wedge dovetail dowel can be placed in from the face of a masonry wall with dovetail channels without having to slide the two pieces down from the top. The two pieces can be slid together to form one combined attachment point for drywall. The plastic pieces can be formed to extend out from the face of the masonry wall the same distance as a wood furring strip.

Tapping the two halves of the dowel together with a hammer expands the width of the two halves further compressing the two pieces against the sides of the dovetail channel locking the combination in place through friction. These steps are repeated over and over creating the required 16 inch by 8 inch grid pattern of dowels that would replace the wood furring strips.

Plastic furring attachment points would reduce heat transfer from the drywall or finish material to the masonry wall compared with wood furring strips.

Plastic split wedge dovetail dowels are resistant to mold unlike wood furring strips.

Plastic split wedge dovetail attachment points require no drilling and screwing into the masonry unlike wood furring strips.

The present invention solves many of the problems associated with wood furring strips and expands the uses of dovetail channels formed in construction materials.

Building Codes will soon require continuous insulation as energy efficiency becomes more of an issue in our society. Masonry walls with wood furring strips and discontinuous insulation between the furring strips will not meet these future requirements. Masonry walls construction with furring strips will become obsolete when these requirements are added to the code.

As can be seen, there is a need for simpler furring strips made of an insulating material such as plastic that will meet the requirements of continuous insulation.

Split wedge dovetail dowels expand the uses for dovetail channels by providing a way to lock the dowels into place without the need for glue or screws.

Split wedge dovetail dowels expand the uses for dovetail channels by providing a way to insert the dowel into the dovetail channel without having to slide the dowel in from the end of the channel.

### SUMMARY OF THE INVENTION

In one aspect of the present invention, a configuration of dovetail dowels where the dowels are split longitudinally into two halves such that the two halves of the dowel can fit past the front smaller width face of a dovetail channel.

The two halves are split at a wedge shaped angle such that when the two halves are slid together within the dovetail channel the wedge shape expands the two halves to a width wider than the dovetail channel compressing the two halves together locking them in place through friction within the restraining dovetail channel.

The contacting edges of the two halves of the dovetail dowel are fashioned with a ridge on one edge and a matching groove on the opposing edge such that the split edge is held in alignment when compressed through wedging action.

The two halves of the dovetail dowel are placed in the dovetail channel separately, slid together at their desired location, and tapped together with a hammer to expand the two halves within the dovetail channel locking the dovetail dowel in place. The combination of the two halves of the dovetail dowel can then be used as an attachment point and/or the two halves can span across two separate matching dovetail channels to act as a connector.

### BRIEF DESCRIPTION OF THE DRAWINGS

FIG. 1A is an orthogonal side view of a dovetail shaped dowel before it is fashioned into two halves for insertion into a dovetail channel.

FIG. 2A is an orthogonal top view of a dovetail channel

FIG. 3A is an orthogonal side view of a dovetail shaped dowel split in half longitudinally with the two halves together

FIG. 3B is an orthogonal side view of a dovetail shaped dowel split in half longitudinally with the two halves separated

FIG. 4A is a close up top view of a matching ridge and groove fashioned along the split surface of two halves of a dovetail dowel

FIG. 5A is a front view of two halves of a dovetail dowel inserted into a dovetail channel before the two halves of the dowel are positioned together

FIG. 5B is a front view of two halves of a dovetail dowel inserted into a dovetail channel after the two halves of the dowel are positioned together

FIG. 6A is an orthogonal view of dovetail dowels spaced in a grid pattern in dovetail channels to provide attachment points for drywall

### DETAILED DESCRIPTION OF THE INVENTION

The following detailed description is of one currently contemplated mode of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a dovetail dowel that expands within a dovetail channel. The dovetail dowels can be used for any purpose that can benefit from a locked dowel attachment point. The dovetail dowels are split in a longitudinal wedge shape such that when the wedge shapes are moved past each other the two halves of the dowel widen.

Dowels are fashioned to a width slightly wider than the widest width of a board or member with a dovetail channel formed in it. The opposing sides of the dowel are mitered to match the dovetail shape of the channel where the attachment is required such that the front face of the dowel is not as wide as the back face of the dowel.

The dowel is split in two longitudinally at an angle no greater than 45 degrees with a groove fashioned on one edge and a matching ridge fashioned on the opposing edge. The dowel is split to a width such that the largest width of each half of the dowel when separated is smaller that the smaller front width of the dovetail channel.

One half of the split wedge dovetail dowel is inserted into the dovetail channel at one location and the other half is inserted into the same dovetail channel at another location. The two halves are moved up and down the channel respectively such that the split longitudinal edges with matching ridge and groove come in contact. Moving the two halves together even further results in the two halves together become wider than the dovetail channel. Tapping with a hammer creates the force necessary to wedge and compress the two halves of dowel inside the restraining confinement of the dovetail channel.

The front face of the dowel is held flush as the compressed dowel forces the ridge into the matching groove. The dowel is locked in place by friction as the compressed dowel is forced against the side of the dovetail channel made of a material strong enough to resist the applied compression forces.

The dowel can span across two separate pieces with matching dovetail channels and can tie those two pieces together as the dowel acts as one piece when compressed together.

The dowel can act as an attachment point for drywall or utilities or other construction accessories that normally would have difficulty otherwise attaching to the member with the dovetail channel formed in it.

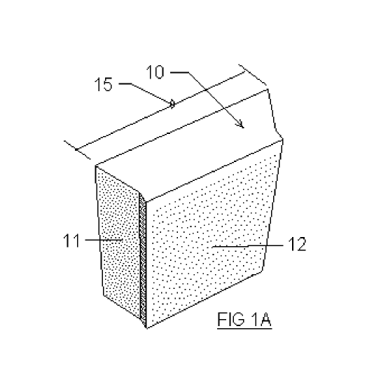

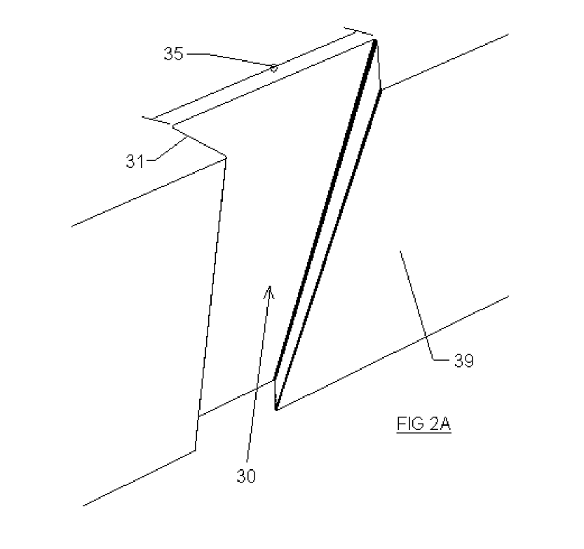

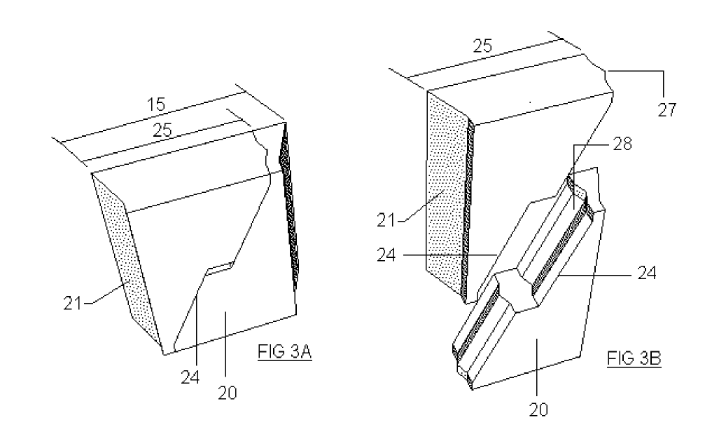

Referring now to the Figures, a dovetail shape dowel 10 is fashioned to a plan view shape that matches the outline shape of dovetail channel 30. The side slope of the dowel 11 on both sides closely matches the side slope of the channel 31. The width of the dowel 15 is about the same width of the channel 35 except it 15 is slightly larger. See FIG. 1A for a view of the dowel 10 and FIG. 2A for a view of the channel 30.

Referring now to FIG. 3A and 3B, the dowel 10 is split into two halves 20 in a longitudinal fashion 24 such that each half is a width 25 smaller than the front face of the dovetail channel 30. When slid together the two halves 20 are expanded to the original dowel width.15

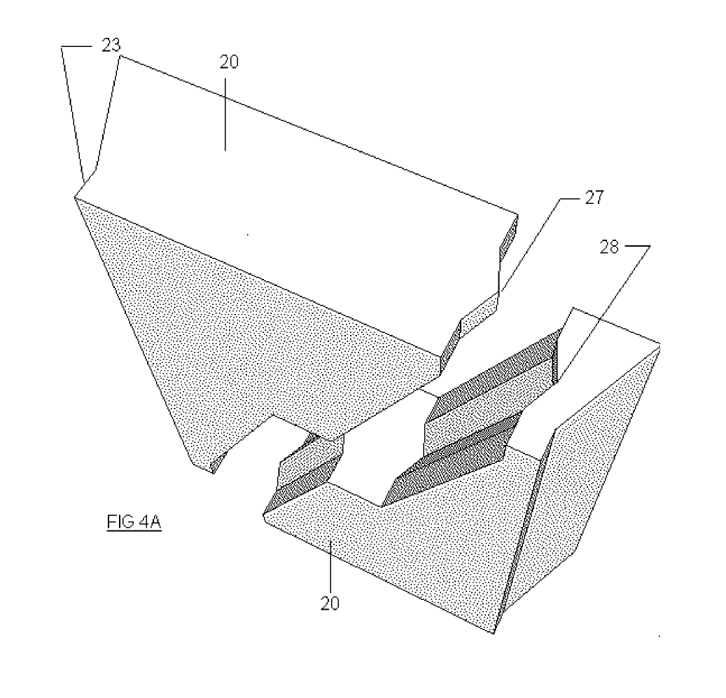

Referring now to FIG. 4A, the contacting edges of the two halves of the dowel 20 are fashioned with groove 28 and matching ridge 27 such that the face of the dowels remain flush when the two halves are compressed together.

The dowels can extend out from the face of the member 39 with the dovetail channel 30 by extending the face of the dowel out 23.

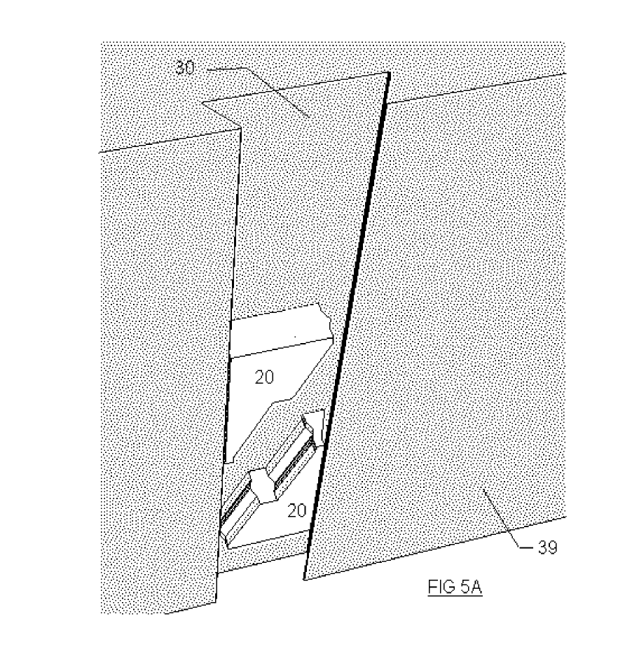

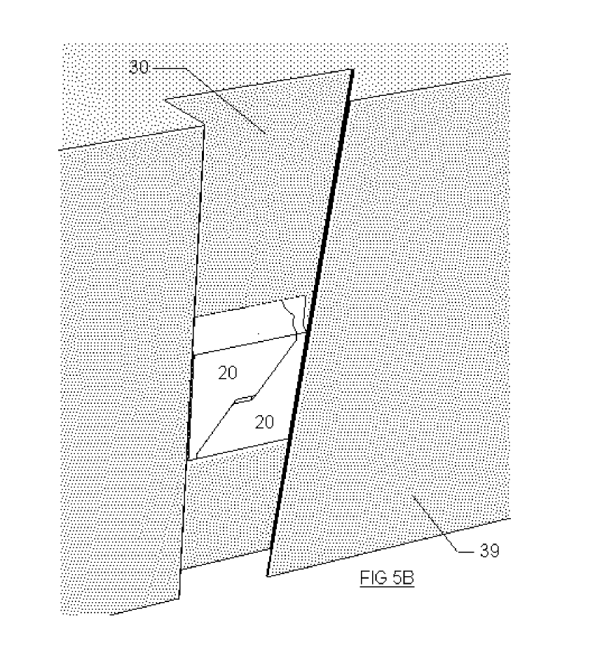

Referring now to FIG. 5A and 5B, the two halves of the dovetail dowel 20 can be inserted past the front face of the dovetail channel 30 in member 39 at separate locations. When slid together the two dowels 20 will be compressed in the dovetail channel 30 and locked in place.

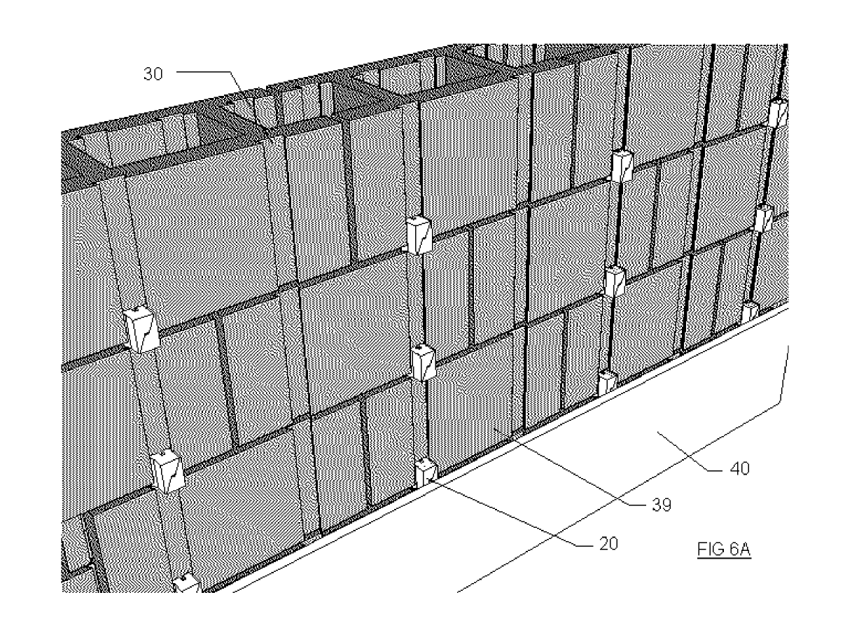

Referring now to FIG. 6A, shows one possible use for split wedge dovetail dowels used as an attachment point for drywall with the attachment points arranged in a 16 inch by 8 inch grid pattern. A wall made of concrete masonry block 39 with dovetail channels 30 molded into the block for their full height at 8 inch centers has dovetail dowel halves 20 made of molded polypropylene locked together in a 16 inch by 8 inch pattern within the dovetail channels 30. ½ inch drywall 40 is placed against the dovetail dowels and can be permanently screwed into place with standard drywall screws.

In one embodiment, strips of EPS foam insulation matching the width and depth of the dowels are placed in the channels between the lines of spaced dowels.

Drywall 40 can not be attached directly to concrete masonry block 39 with drywall screws. Drywall 40 can absorb moisture from concrete masonry block 39 which is not desirable. Dovetail dowels 20 provide an easy way to apply attachment point for drywall to concrete masonry walls. Drywall screws will attach directly to polypropylene dovetail dowels.20 Drywall 40 will not absorb moisture from dovetail dowels. 20

Wood furring strips must be drilled and screwed in concrete masonry masonry block 39. Dovetail dowels 20 are easily tapped into place in pairs with a hammer. Wood furring strips transmit more energy from the drywall into the concrete masonry block than does polypropylene dovetail dowels. Polypropylene dovetail dowels 20 would increase the energy efficiency of a wall system over wood furring strips.

The above shows just one possible use for split wedge dovetail dowels. The dowels and the member with the dovetail channel can be made of any rigid construction material. Another example of a use for split wedge dovetail dowels would be wood dovetail dowels connecting together two pieces of wood with matching dovetail channels fashioned in them such as in furniture manufacturing.

This process creates a split wedge dovetail shaped dowel that can lock in a dovetail shaped channel for connection purposes.

It should be understood, of course, that the foregoing relates to exemplary embodiments of the invention and that modifications may be made without departing from the spirit and scope of the invention as set forth in the following claims.

What is claimed is:

1. A dovetail dowel connector sized to fit within a dovetail channel with the dovetail dowel split or fashioned longitudinally into two halves at an angle that results in two wedge shaped half dovetail dowels that are positioned separately within the dovetail channel then moved together within the dovetail channel with the opposing angled surfaces positioned to expand the two halves withing the confines of the dovetail channel as the two halves are positioned adjacent to each other:

2. The dovetail dowel connector of claim 1, wherein the combined halves of the dowels together are slightly larger than the dovetail channel such that when the two halves are positioned adjacent to each other the two halves are compressed within the dovetail channels and locked in place through friction.

3. The dovetail dowel connector of claim 1, wherein the adjacent angled surfaces of the dovetail dowel halves are fashioned with a longitudinal groove along the length of the surface on one half and are fashioned with a matching ridge along the length of the surface on the adjacent half.

4. The dovetail dowel connector of claim 1, wherein the dovetail channels are formed at regular intervals in a wall constructed of masonry concrete block, the dovetail dowels are molded from polypropylene, and multiple dowels are spaced in a grid pattern along the face of the wall to act as insulated attachment points for the attachment of drywall or other construction finishes.
